(19) United States
(12) Patent Application Publication
(10) Pub. No.: US 2011/0271037 A1
(43) Pub. Date: Nov. 3, 2011

(54) STORAGE DEVICE PERFORMING DATA INVALIDATION OPERATION AND DATA INVALIDATION METHOD THEREOF

(75) Inventors: Sang-jin Oh, Suwon-si (KR); Eun-jin Choi, Suwon-si (KR)

(73) Assignee: SAMSUNG ELECTRONICS CO., LTD., Suwon-si (KR)

(21) Appl. No.: 12/911,082

(22) Filed: Oct. 25, 2010

Related U.S. Application Data
(60) Provisional application No. 61/255,119, filed on Oct. 27, 2009.

(30) Foreign Application Priority Data
May 4, 2010 (KR) 10-2010-0042065

(51) Int. Cl. G06F 12/02

(52) U.S. Cl. 711/103; 711/170; 711/E12.008

(57) ABSTRACT

A storage device of one aspect includes a data storage medium including a plurality of memory blocks, and a storage controller which outputs a free memory block signal to a host device, and which is responsive to an externally received invalidation command from the host device to selectively invalidate data stored in the memory blocks of the storage medium. The free memory block signal is in accordance with a free memory block status of the data storage medium.

### CROSS-REFERENCE TO RELATED APPLICATIONS

A claim of priority under 35 U.S.C. §119 is made to U.S. provisional application No. 61/255,119, filed Oct. 27, 2009, and to Korean patent application no. P2010-0042065, filed on May 4, 2010, the contents of which are incorporated herein by reference in their entirety.

### BACKGROUND

The inventive concepts described herein generally relate to data storage devices and to systems including data storage devices, and more particularly, to storage devices and systems operative to execute data invalidation of files corresponding to deleted files.

User devices (also called computer systems herein) generally include a host device containing one or more central processing units (CPU) and a data storage device in data communication with the host device. Non-limiting examples of user devices include personal computers, digital cameras, camcorders, portable phones, MP3 players, Portable Multimedia Players (PMPs), Personal Digital Assistants (PDAs), and High Definition Televisions (HDTV). Non-limiting examples of data storage devices include memory cards, Universal Serial Bus (USB) memories, Solid State Drives (SSDs) and Hard Disk Drives (HDDs). The storage device may constitute an internal component of the user device, or the storage device may be external the user device and operatively coupled by wired, wireless and/or optical communication. Further, the internal memory of the data storage device may be volatile and/or nonvolatile memory. Non-limiting examples of volatile memory include Dynamic Random Access Memory (DRAM) and Static Random Access Memory (SRAM). Non-limiting examples of nonvolatile memory includes Erasable Programmable Read Only Memory (EPROM), Ferroelectric Random Access Memory (FRAM), Phase-change Random Access Memory (PRAM), Magnetoresistive Random Access Memory (MRAM) and flash memory device.

The host device generally includes a file system to control the creation and deletion of files. In the case of deletion, the host file system does not actually cause a file to be physically deleted, but instead modifies or corrects metadata to designate that the file is invalid. That is, the content of the deleted file is treated as invalid data in the file system, but it exists as data in the storage device. The storage device recognizes a memory block including the data of a deleted (invalid) file as an invalid block, and an operation commonly known as a merge operation and/or garbage collection (merge/garbage collection) is executed with respect to blocks containing invalid files.

In order to enhance system performance, the host may provide an invalidation command (also known as a trim command) in order for the content of a deleted file to be invalidated in the storage device. The invalidation command, which may be provided by the host device each time data is deleted, includes information (for example, address information) for designating a data region to be deleted. The thus invalidated data can be excluded from merge/garbage collection.

### SUMMARY OF THE INVENTION

According to one or more aspects of the inventive concepts, a storage device is provided which includes a data storage medium including a plurality of memory blocks, and a storage controller which outputs a free memory block signal to a host device, and which is responsive to an externally received invalidation command from the host device to selectively invalidate data stored in the memory blocks of the storage medium. The free memory block signal is in accordance with a free memory block status of the data storage medium.

According to one or more other aspects of the inventive concepts, a storage device is provided which includes a data storage medium including a plurality of memory blocks, and storage controller. The storage controller receives an invalidation command from a host device, logs the invalidation command when a target address of the invalidation command denotes a frequently updated region of the data storage medium, and executes the invalidation command when the target address of the invalidation command does not denote a frequently updated region of the data storage medium.

According to one or more other aspects of the inventive concepts, a computer system is provided which includes a host device which generates an invalidation command, and a storage device. The storage device includes a data storage medium including a plurality of memory blocks, and a storage controller which executes the invalidation command generated by the host device to selectively invalidate data stored in the memory blocks of the storage medium. Here, at least one of the generation of the invalidation command by the host device and the execution of the invalidation command by the storage controller is in accordance with a free memory block status of the data storage medium.

According to one or more other aspects of the inventive concepts, a computer system is provided which includes a host device which generates an invalidation command, and a data storage device which includes a storage controller and a data storage medium including a plurality of memory blocks. The storage controller receives the invalidation command from the host device, logs the invalidation command when a designated address of the invalidation command denotes a frequently updated region of the data storage medium, and executes the invalidation command when the designated address of the invalidation command does not denote a frequently updated region of the data storage medium.

According to still one or more other aspects of the inventive concepts, a method of operating a storage device is provided, where the storage device includes a data storage medium including a plurality of memory blocks. The method includes outputting a free memory block signal to a host device, where the free memory block signal is in accordance with a free memory block status of the data storage medium, and selectively invalidating data stored in the memory blocks of the storage medium in response to an invalidation command received from the host device.

According to yet one or more other aspects of the inventive concepts, a method of operating a storage device is provided, where the storage device includes a data storage medium including a plurality of memory blocks. The method includes receiving an invalidation command from a host device, logging the invalidation command when a target address of the invalidation command denotes a frequently updated region of the data storage medium, and executing the invalidation command when the target address of the invalidation command does not denote a frequently updated region of the data storage medium.

According to one or more other aspects of the inventive concepts, a method of operating a computer system is provided, where the computer system includes a host device and a storage device which includes data storage medium including a plurality of memory blocks. The method includes generating, by the host device, an invalidation command, and executing, by the storage device, the invalidation command generated by the host device to selectively invalidate data stored in the memory blocks of the storage medium. At least one of the generation of the invalidation command by the host device and the execution of the invalidation command by the storage device is in accordance with a free memory block status of the data storage medium.

According to still one or more other aspects of the inventive concepts, a method of operating a computer system is provided, where the computer system includes a host device and a storage device which includes data storage medium including a plurality of memory blocks. The method includes transmitting, by the host device, an invalidation command to the storage device, logging, by the storage device, the invalidation command when a designated address of the invalidation command denotes a frequently updated region of the data storage medium, and executing, by the storage device, the invalidation command when the designated address of the invalidation command does not denote a frequently updated region of the data storage medium.

### BRIEF DESCRIPTION OF THE DRAWINGS

The above and other aspects of the inventive concepts will become readily apparent from the detailed description that follows, with reference to the accompanying drawings, in which:

FIG. 1 is a table for use in explaining a file invalidation operation;

FIG. 2 is a block diagram illustrating a user device according to an embodiment of the inventive concepts;

FIG. 3 is a block diagram illustrating an example of a controller illustrated in FIG. 2;

FIG. 4 is a block diagram illustrating another example of a controller illustrated in FIG. 2;

FIG. 5 is a flowchart for use in describing a file invalidation method according to an embodiment of the inventive concepts;

FIG. 6A is a flowchart for use in describing an operation of a host device illustrated in FIG. 5;

FIG. 6B is a flowchart for use in describing an operation of a storage device illustrated in FIG. 5;

FIG. 7 is a flowchart for use in describing a file invalidation method according to another embodiment of the inventive concepts;

FIG. 8A is a flowchart for use in describing an operation of a host device illustrated in FIG. 7;

FIG. 8B is a flowchart for use in describing an operation of a storage device illustrated in FIG. 7;

FIG. 9 is a diagram illustrating an example of a bitmap structure for detecting a frequently-updated region according to another embodiment of the inventive concepts;

FIGS. 10A and 10B are flowcharts for use in describing a file invalidation method according to another embodiment of the inventive concepts;

FIG. 11 is a block diagram illustrating a memory system according to an embodiment of the inventive concepts; and

FIG. 12 is a block diagram illustrating a computing system according to an embodiment of the inventive concepts.

### DETAILED DESCRIPTION OF EMBODIMENTS

Various example embodiments are described with reference to the accompanying drawings, where like reference numbers are used to denote like or similar elements. The inventive concepts may, however, be embodied in many different forms and should not be construed as limited to the embodiments set forth herein.

To facilitate understanding, a number of non-limiting descriptive terms may be utilized which are not intended to define the scope of the inventive concepts. For example, although the terms “first”, “second”, etc. may be used herein to describe various elements, these elements should not be limited by these terms. These terms are simply used to distinguish one element from another. For example, a first element could be termed a second element, and, similarly, a second element could be termed a first element, without departing from or limiting the scope of the inventive concepts. Likewise, the words “over”, “under”, “above”, “below”, etc. are relative terms which are not intended to limit the inventive concepts to a particular device orientation. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A solid state disc (SSD) constitutes an example of a storage device of the inventive concepts. However, the inventive concepts may also be applied to other types of storage devices. Further, NAND flash memory constitutes an example of the storage media of the storage device of the inventive concepts. Again, however, it will be understood that the inventive concepts are not limited to flash memory. As non-limiting examples, PRAM, MRAM, ReRAM, FRAM and NOR flash memory may be utilized as storage media, and the storage media may also be configured by heterogeneous memory devices utilized in common.

In the description that follows, the term memory “block” denotes any defined memory region of the memory media into which the memory media is logically and/or physically segmented. A memory block, for example, can be constituted by a memory chip among a plurality of memory chips of the storage media, a sector among a plurality of sectors of the storage media, a data region among a plurality of data regions of the storage media, and so on. The terms “free block” or “free memory blocks” denotes a memory block that is presently available for storing write data, i.e., without first being erased. For example, a free block may denote a memory block that has previously been erased in a merge operation.

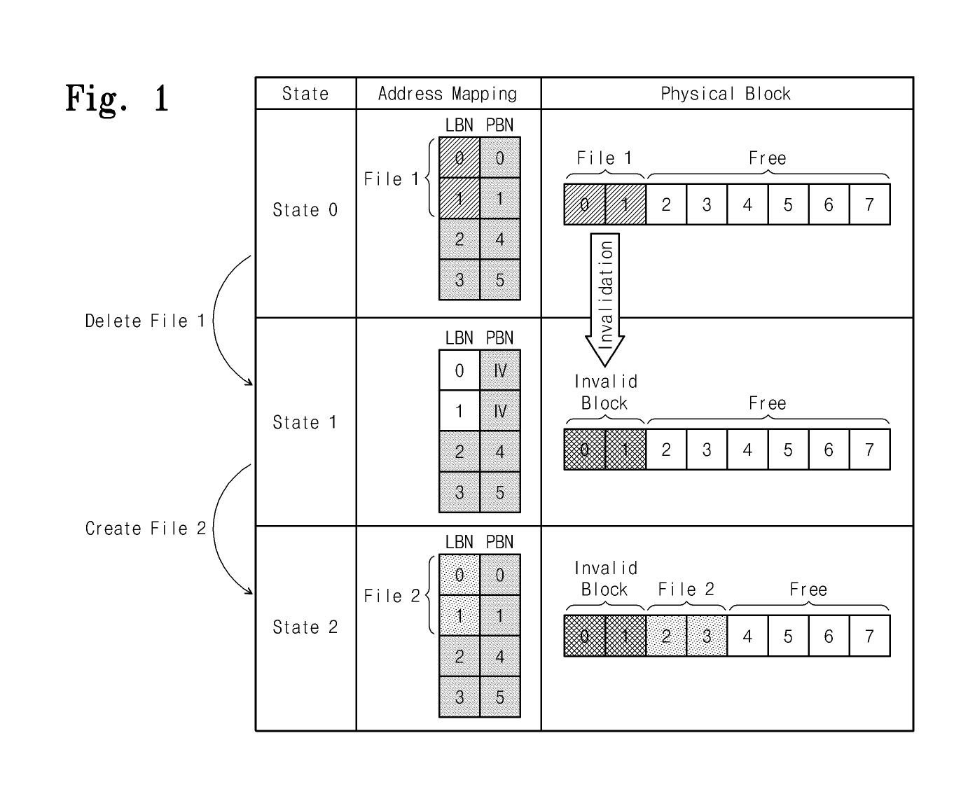

A file invalidation operation will first be described with reference to the example depicted by the table of FIG. 1.

In an initial “State 0”, an address mapping (for example, a mapping table) maps logic block addresses (LBN) 0, 1, 2, 3 to respective physical block addresses (PBN) 0, 1, 4, 5. Further, in State 0, it is assumed that a data File 1 is stored in PBN 0, 1 (having a mapped correspondence to LBN 0, 1). The remaining PBN 2˜7 are to be free blocks in this example.

Next, a command is received which dictates that File 1 has been “deleted.” In particular, when the File 1 is deleted by a file system of a host device, the host device transmits an “invalidation command” (an example of which is known as a “TRIM command) for LBN 0, 1 to the storage device. For example, a host operating system (O/S) may generate a TRIM command informing a non-volatile storage device (e.g., SSD) of the deletion of files (or pages). The storage device is responsive thereto to copy a non-volatile memory block containing the deleted files as well as any non-deleted files to a temporary RAM memory (e.g., cache). Once copied to cache, the storage device erases the non-volatile memory block, and then writes back only the non-deleted files from cache to the erased memory block. In this manner, the deleted file locations of the non-volatile memory block are available for new file write operations without the need for executing a time-consuming overwrite operation.

As stated above, when the File 1 is deleted by the file system of the host device, the host device transmits an “invalidation command” for LBN 0, 1 to the storage device. This is represented by State 1 of FIG. 1. Data corresponding to File 1 that is stored in PBN 0, 1 is invalidated according to the invalidation command, for example by the update of metadata for the deleted File 1 in the storage device. Accordingly, the data corresponding to File 1 that is written in PBN 0, 1 may be excluded from merge/garbage collection. In addition, LBN 0, 1 now have a status in which a new file may be allocated thereto, and PBN 0, 1 are designated as invalid (IV) in the mapping table of the storage device.

State 2 represents the case where new File 2 is created in the storage device. In this example, the new File 2 is allocated to LBN 0, 1, and LBN 0, 1 is mapped to mapped to PNB 2, 3 corresponding to the free blocks where File 2 is stored.

The invalidation command is particular useful in the case where the storage medium includes nonvolatile memory that is not capable of executing a data overwrite (i.e., memory cell blocks must be erased before written). The invalidation command allows for the storage device to recognize a file, which is deleted from a file system, as invalid data, rather than executing an erase-before-write operation. This can reduce operational load at the data storage device.

However, the invalidation command is also attended by operational load, such as updating of metadata. This load can become significant, particularly in the case where the host device issues an invalidation command each time frequently accessed data is updated.

The inventive concepts described herein are aimed at reducing the load associated with the invalidation command. Referring again to the example of FIG. 1, it can be seen that sufficient free block space was available to accommodate File 2, and thus execution of invalidation command as described above was an excessive procedure. The inventive concepts are at least partly directed to suppressing excessive generation of invalidation commands. Other inventive concepts are at least partly directed to the logging of invalidation commands when target addresses denote frequently updated region of the data storage device.

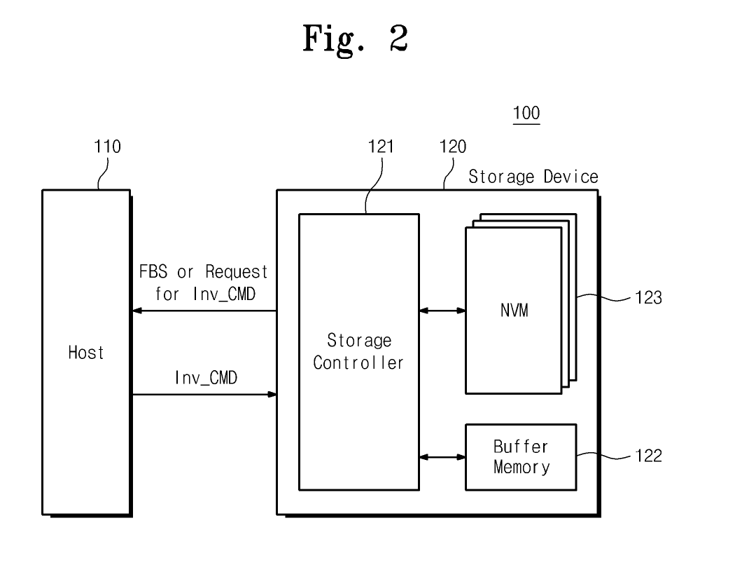

FIG. 2 is a block diagram illustrating a user device 100 according to an embodiment of the inventive concepts.

Referring to FIG. 2, a user device 100 of this example includes a host device 110 and a storage device 120.

The storage device 120 includes a storage controller 121, a buffer memory 122, and a nonvolatile memory 123.

The host device 110 includes a central processing unit (CPU), main memory (e.g., DRAM and/or SRAM) and a file system (not shown), and controls an operation of the storage device 120 by issuance of commands and exchange of data. When a file stored in the storage device 120 is deleted from the host device 110, the host device 110 transfers an invalidation command Inv_CMD for a deleted file to the storage device 120.

In the example of this embodiment, the storage device 120 is a solid state disc (SSD) that includes nonvolatile memory (NVM). The inventive concepts, however, are not limited to the storage device 120 being an SSD. The storage device 120 is operative according to commands received from the host device 110. For example, as described above, the storage device 120 is responsive to the invalidation command Inv_CMD form the host device 110 to invalidate data or a data region corresponding to a deleted file.

The storage device 120 includes a storage controller 121, a buffer memory 122, and a nonvolatile memory 123.

The storage controller 121 controls the nonvolatile memory (NVM) 123 in response in response to requests received from the host device 110. In particular, the storage controller 121 controls the exchange of data between the host device 110 and the nonvolatile memory 123. The storage controller 121 decodes commands received from the host device 110, and accesses or controls the nonvolatile memory 123 and/or the buffer memory 122 in accordance with the decoded commands.

The buffer memory 122 may be an input/output buffer which temporarily stores data to be written (“write data”) to the nonvolatile memory 123 and data to be read (“read data”) from the nonvolatile memory 123. Generally, a data transfer rate of the bus protocol (for example, SATA or SAS) of the host device 110 is far higher than a data transfer rate to and from the nonvolatile memory 123. The buffer memory 122 is provided to accommodate and manage this difference in data transfer rates.

The nonvolatile memory 123 constitutes a storage medium of the storage device 120. For example, the nonvolatile memory 123 may be configured with NAND-type flash memory having mass storage characteristics. Alternatively, or in addition, the nonvolatile memory 123 may be configured with NOR flash memory and/or next-generation nonvolatile memory such as PRAM, MRAM, ReRAM, and/or FRAM memory. Alternatively, all or a portion of the storage medium of the storage device 120 may be configured with volatile DRAM and/or SRAM memory.

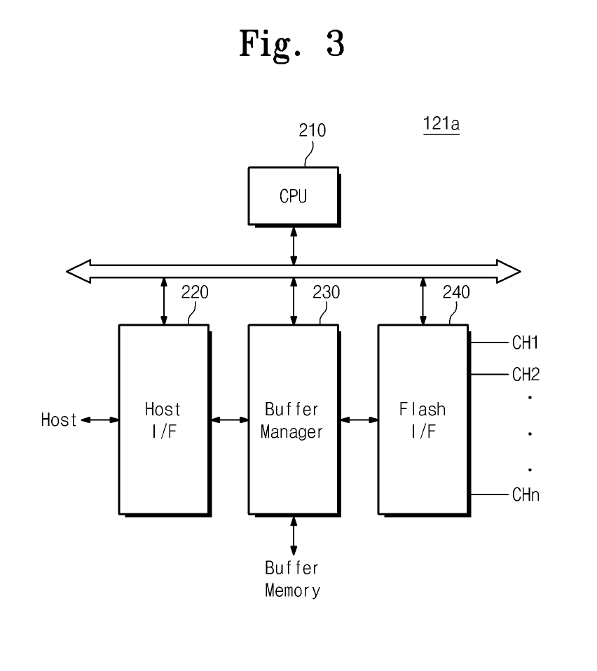

FIG. 3 is a block diagram illustrating an example of the storage controller 121 shown in FIG. 2.

Referring to FIG. 3, a storage controller 121a according to an embodiment of the inventive concepts includes a Central Processing Unit (CPU) 210, a host interface 220, a buffer manager 230, and a flash interface 240.

The CPU 210 transfers various control information necessary for a read/writing operation to the registers of the host interface 220 and flash interface 240. For example, when a read/write command is received, it is stored in a register of the host interface 220. The host interface 220 informs the CPU 210 that the read/writing command has been received. A similar operation is also executed between the CPU 210 and the flash interface 240. The CPU 210 controls the various components of the storage device 120 (FIG. 2) according to firmware.

The host interface 220 provides physical connection (e.g., wired, wireless, optical, etc.) between the host device 110 and storage device 120 in accordance with a bus format of the host device 110. The bus format of the host device 110 may, for example, be configured in with bus protocols such as Universal Serial Bus (USB), Small Component Small Interface (SCSI), Peripheral Component Interconnection (PCI) express, Advanced Technology Attachment (ATA), Parallel-ATA (PATA), Serial-ATA (SATA) and/or Serial Attached SAS (SCSI).

The buffer manager 230 controls the read and writing operation of the buffer memory 122 (see FIG. 2). For example, the buffer manager 230 temporarily stores writing data or read data.

The flash interface 240 is configured to exchange data with the nonvolatile memory 123. The flash interface 240 distributes write data, which is transferred from the buffer memory 122, over respective memory channels CH1 to CHn. Read data from the nonvolatile memory 123 is received over the channels CH1 to CHn and stored in the buffer memory 122 via the flash interface 240.

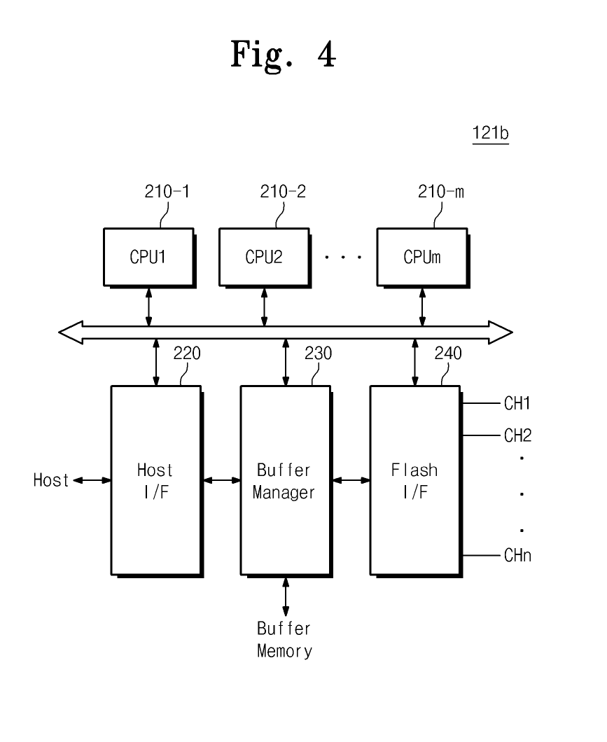

FIG. 4 is a block diagram illustrating another example of the storage controller shown in FIG. 2.

The storage controller 121b of FIG. 4 is similar to that of FIG. 3, except that the single CPU 210 of FIG. 3 is replaced with a plurality of parallel CPUs 210-1˜210-m. This configuration allows for multi-tasking parallel processing, which can enhance operational speeds. That is, processing tasks can be segmented among the parallel CPUs 210-1˜210-m, thus operating at high processing speed even in the case of a relatively low clock frequency. The host interface 220, the flash interface 240 and the buffer manager 230 are substantially the same as those described previously in connection with FIG. 3, and thus a detailed description thereof is omitted here to avoid redundancy.

The configurations of FIGS. 3 and 4 are merely presented as examples, and further, additional elements can be added to storage controllers 121a and 121b. For example, the storage controllers 121a and/or 121b may be further equipped with a read only memory (ROM) circuit block and an Error Correction Code (ECC) circuit block.

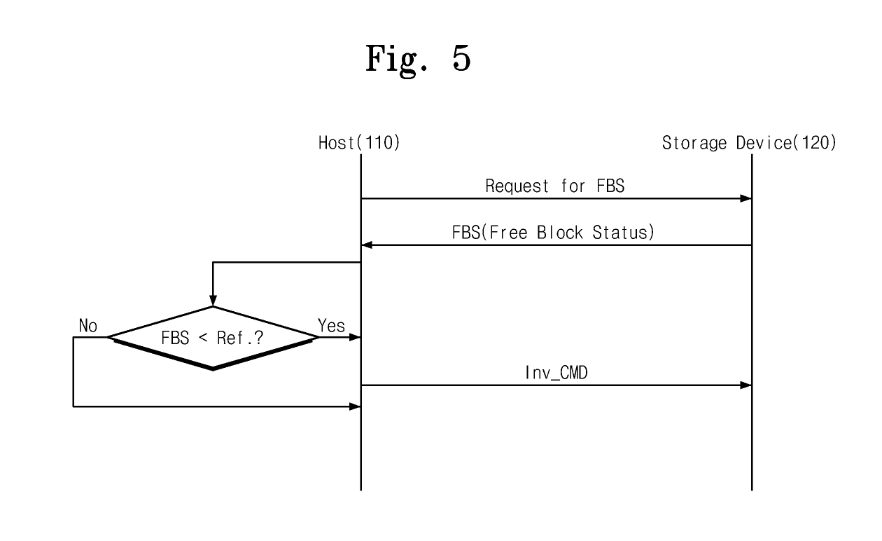

FIG. 5 is a flowchart for use in describing a method of operating a user device such as that of FIG. 2 according to an embodiment of the inventive concepts. As explained below, the example of this embodiment is characterized by the host device 110 making a determination as to whether to issue an invalidation command based on the free block status of the storage device 120.

Referring to FIG. 5, the host device 110 requests the free block status (FSB) of the storage device 120. For example, the host device 110 may issue the FSB request each time an invalidation command Inv_CMD would otherwise be issued, e.g., each time a file is deleted. Alternatively, or in addition, the host device 110 may periodically issue the FSB request according to a given timetable, and/or when a system performance (e.g., write speed) of the storage device falls below a given threshold. In addition, the storage controller 121 of the storage device may also be responsive to an externally received request from an external device other than the host device 110 to transmit the free memory block status to the external device.

The storage device 120 is responsive to the FSB request from the host device 110 to determine a free block status of the storage device 120. As shown in FIG. 5, the free block status is transmitted to the host device 110. In the example of this embodiment, the free block status includes the number of free blocks that are presently capable of storing write data. However, the information included in the free block status is not limited thereto, so long as the information is sufficient for the host device 110 to make a determination as to whether an invalidation command Inv_CMD should be sent (described next). For example, the free block status may instead denote the number of non-free blocks, or a ratio of the number of free blocks to the total number of blocks that are included in the storage device 120.

The host device 110 receives the free block status from the storage device 120, and utilizes the free block status to determine whether to issue the invalidation command Inv_CMD. In the example of the present embodiment, the determination is based upon a comparison between the free block status and a reference value which may, for example, be stored in a register of the host device 110. In addition, the reference value may be variably set by the user. For example, in the example of the present embodiment where the free block status represents the number of free blocks, the reference value may be set as the minimum number of free blocks that are needed to obtain satisfactory or optimum performance of storage device 120. Similarly, in the example where the free block status represents a ratio of free blocks to total memory blocks, reference value may be set as the minimum ratio needed to obtain satisfactory or optimum performance of storage device 120.

Referring still to FIG. 5, in the example of the present embodiment, when the free block status is less than the reference value, the host device 110 issues the invalidation command Inv_CMD to thereby invalidate files which have been deleted from the file system but not yet invalidated at the storage device 120. That is, the storage device 120 is responsive to the invalidation command Inv_CMD to invalidate addressed blocks as described previously. On the other hand, when the free block status is equal to or greater than the reference value, the host device 110 does not issue the invalidation command Inv_CMD since a sufficient number of free blocks exists in the storage device 120.

According to the embodiment of the inventive concepts as described above with reference to FIG. 5, when a file is deleted from the file system, the host device 110 does not immediately issue an invalidation command Inv_CMD for the deleted file. Instead, the host device 110 utilizes a free block status from the storage device 120, obtained either previously (periodically) or after issuance of a request, to determine whether to issue an invalidation command Inv_CMD.

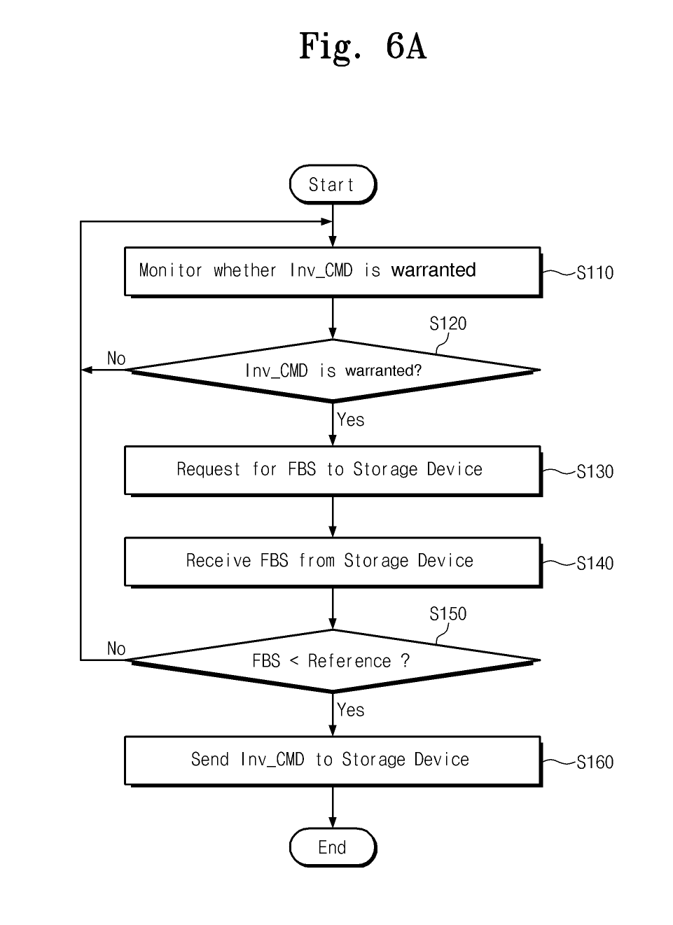

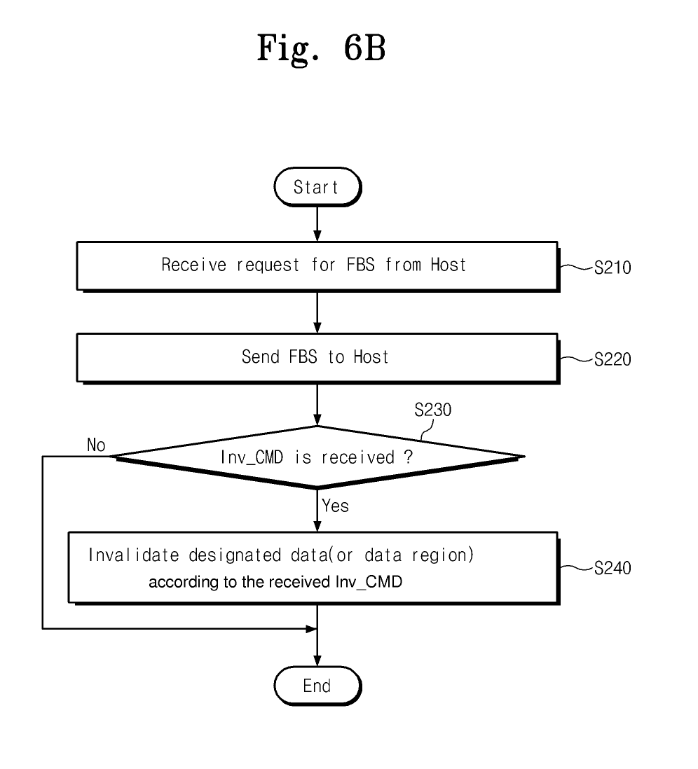

FIGS. 6A and 6B are flowcharts for use in describing operational examples of the host device 110 and the storage device 120, respectively, according to an embodiment of the inventive concepts. In particular, FIG. 6A is a flowchart illustrating operations of the host device 110 when executing the method of FIG. 5, according to an embodiment of the inventive concepts. FIG. 6B is a flowchart illustrating operations of the storage device 120 when executing the method of FIG. 5, according to an embodiment of the inventive concepts.

Referring to FIG. 6A, the host device 110 monitors whether issuance of an invalidation command Inv_CMD is warranted (S110). For example, the host device 110 may monitor whether a file has been deleted in the file system of the host device 110. As another example, the host device 110 may be configured to issue invalidation commands Inv_CMD at given periodic intervals, and in this case the host device 110 may monitor the occurrence of the periodic intervals. As another example, the host device 110 may be configured assess the system performance (e.g., write speed) of the storage device 120. In this case, the host device may monitor whether system performance has fallen below a given threshold. However, the monitoring carried out at S110 of FIG. 6A is not limited to these examples.

In the case where the monitoring of S110 determines that issuance of an invalidation command Inv_CMD is warranted (Yes at S120), the host device 110 issues a request for a free block status (FBS) to the storage device 120 (S130). The free block status (FBS) is then received from the storage device 120 (S140), and a comparison is made between the received free block status and a reference value (S150).

In the example of the present embodiment, in the case where the free block status (FBS) is less than the reference value (No at S150), the host device 110 does not issue the invalidation command Inv_CMD, and instead returns to the beginning of the process to monitor whether issuance of another invalidation command Inv_CMD is warranted (S110). Although not shown in the FIG. 6A, the host device 110 may log invalidation data (e.g., address data) associated with non-issued invalidation command(s) Inv_CMD in a data table or the like for later issuance. In this manner, the data associated with non-issued invalidation command(s) Inv_CMD is accumulated for later issuance.

On the other hand, in the case where the free block status (FBS) is greater to or equal than the reference value (Yes at S150), the host device 110 issues the invalidation command Inv_CMD to the storage device 120 in order to increase the number of free blocks of the storage device 120. The issued invalidation command Inv_CMD may also include logged invalidation data relating to previously non-issued invalidation commands Inv_CMD. At this time, the host device 120 process ends (as shown) or returns to S110 to monitor whether issuance of another invalidation command Inv_CMD is warranted.

Referring now to FIG. 6B, the storage device 120 receives a request for free block status (FBS) from the host device 110 (S210).

The storage device 120 determines the number of free memory blocks among the memory blocks thereof in response to the FBS request from the host device 110, and transmits the number of free memory blocks to the host device 110 (S220). Alternatively, for example, the storage device 120 calculates a ratio of the free blocks to total memory blocks, and transmits the same to the host device 110.

After transmitting the free block status to the host device 110, the storage device 120 determines if an invalidation command Inv_CMD has been received from the host device 110 in return (S230). If not an invalidation command Inv_CMD is received (No at S230), the process is terminated.

On the other hand, if an invalidation command Inv_CMD is received (Yes at S230), the storage device 120 invalidates data or a data region that is designated by the invalidation command Inv_CMD (S240). The invalidation command Inv_CMD from the host device 110 may designate one or multiple files. In the case where multiple files are designated, or a plurality of invalidation commands Inv_CMDs are received, the storage device 120 may at one time invalidate data or a data region corresponding to the multiple files. As noted previously, data that has been invalidated by the storage device 120 may be excluded from merge/garbage collection of the storage device 120.

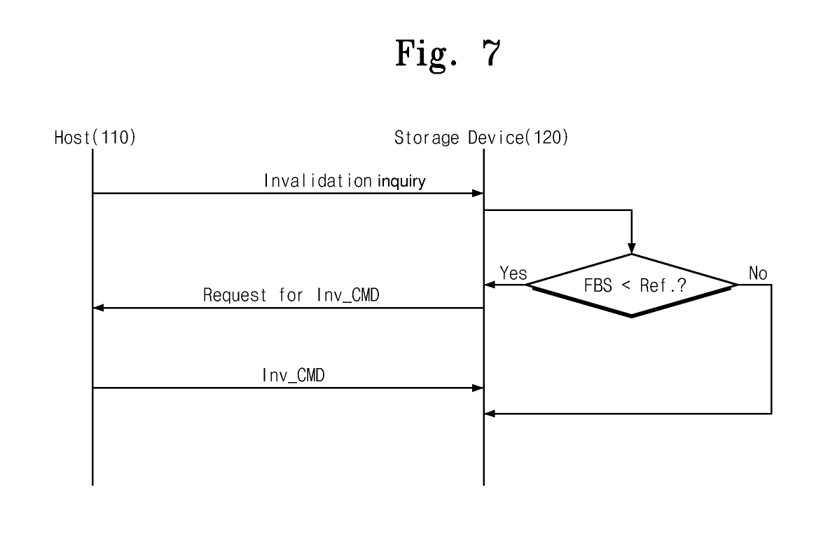

FIG. 7 is a flowchart for use in describing a method of operating a user device such as that of FIG. 2 according to another embodiment of the inventive concepts. As explained below, the example of this embodiment is characterized by the storage device 120 making a determination as to whether the host device 110 should issue an invalidation command based on the free block status of the storage device 120.

Referring to FIG. 7, the host device 110 issues an invalidation inquiry to the storage device 120 as to whether invalidation is needed at the storage device 120. For example, the host device 110 may issue the invalidation inquiry each time an invalidation command Inv_CMD would otherwise be issued, i.e., each time a file is deleted. Alternatively, or in addition, the host device 110 may periodically issue the invalidation inquiry according to a given timetable, and/or when a system performance (e.g., write speed) of the storage device 120 falls below a given threshold.

The storage device 120 is responsive to the invalidation inquiry from the host device 110 to determine whether a free block status of the storage device 120 indicates that invalidation is needed. In the example of the present embodiment, the determination is based upon a comparison between the free block status and a reference value which may, for example, be stored in a register of the storage device 120. In addition, the reference value may be variably set by the user. For example, in the case where the free block status denotes the number of free blocks or non-free blocks that are presently capable of storing write data, the storage device 120 compares the free block status with a reference value. As other example, in the case where the free block status denotes the ratio of the number of free blocks to the total number of blocks that are included in the storage device 120, the storage device 120 compares the free block status with a reference ratio.

In the example of the present embodiment where the free block status represents the number of free blocks, the reference value may be set as the minimum number of free blocks that are needed to obtain satisfactory or optimum performance of storage device 120. Similarly, in the example where the free block status represents a ratio of free blocks to total memory blocks, reference value may be set as the minimum ratio needed to obtain satisfactory or optimum performance of storage device 120.

Referring still to FIG. 7, in the example of the present embodiment, when the free block status is less than the reference value, the storage device 120 transmits a request for an invalidation command Inv_CMD to the host device 120. The invalidation command Inv_CMD is then received from the host device 110 to thereby invalidate files which have been deleted from the file system but not yet invalidated at the storage device 120. That is, the storage device 120 is responsive to the invalidation command Inv_CMD to invalidate addressed blocks as described previously. On the other hand, when the free block status is equal to or greater than the reference value, the storage device 1120 does not transmit the request for an invalidation command Inv_CMD since a sufficient number of free blocks exists in the storage device 120.

According to the embodiment of the inventive concepts as described above with reference to FIG. 7, when a file is deleted from the file system, the host device 110 does not immediately issue an invalidation command Inv_CMD for the deleted file. Instead, the host device 110 sends an invalidation inquiry to the storage device 120 and awaits receipt of a request for an invalidation command Inv_CMD from the storage device 120. If no request for an invalidation command Inv_CMD from the storage device 120 is received, then the host device 110 does not issue an invalidation command Inv_CMD.

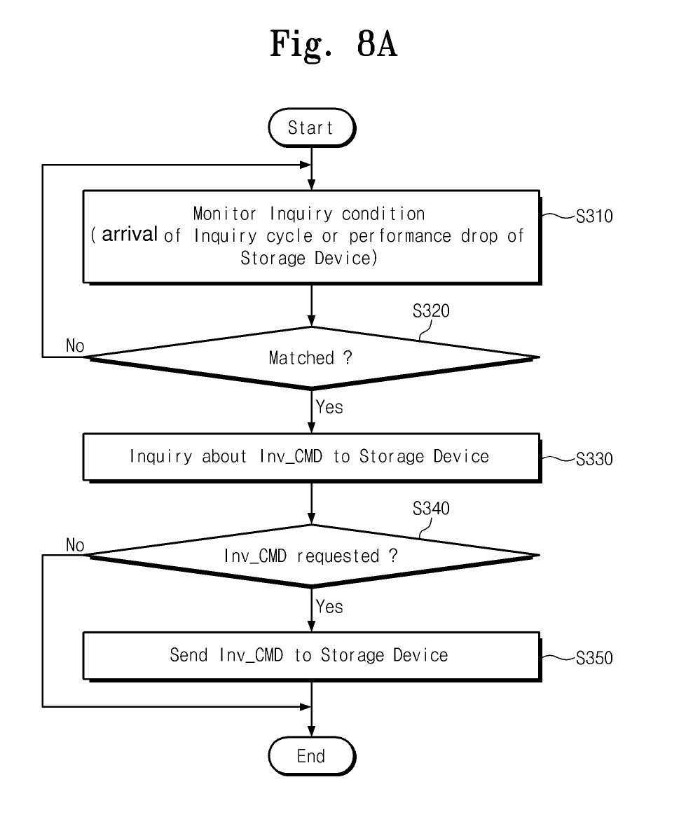

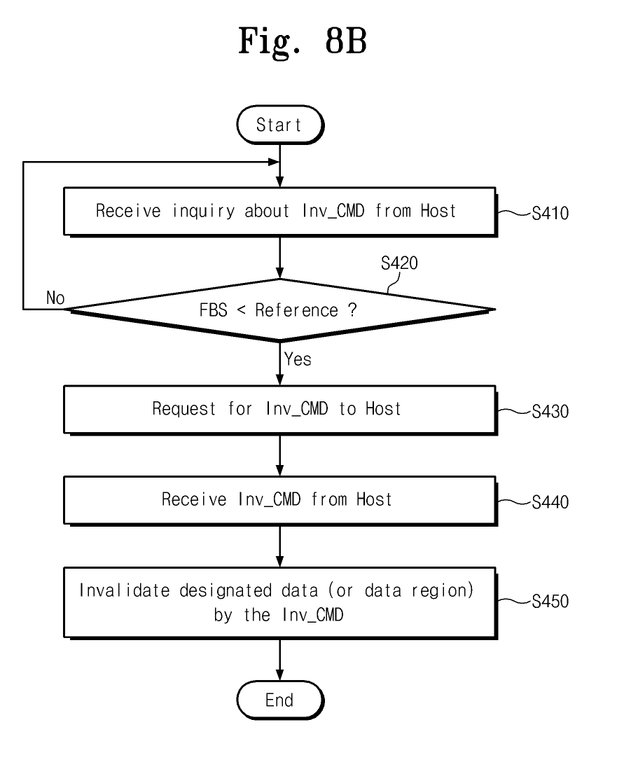

FIGS. 8A and 8B are flowcharts for use in describing operational examples of the host device 110 and the storage device 120, respectively, according to an embodiment of the inventive concepts. In particular, FIG. 8A is a flowchart illustrating operations of the host device 110 when executing the method of FIG. 7, according to an embodiment of the inventive concepts. FIG. 8B is a flowchart illustrating operations of the storage device 120 when executing the method of FIG. 7, according to an embodiment of the inventive concepts.

Referring to FIG. 8A, the host device 110 monitors whether issuance of an invalidation command Inv_CMD is warranted (S310). For example, the host device 110 may monitor whether a file has been deleted in the file system of the host device 110. As another example, the host device 110 may be configured to issue invalidation commands Inv_CMD at given periodic intervals, and in this case the host device 110 may monitor the occurrence of the periodic intervals. As another example, the host device 110 may be configured assess the system performance (e.g., write speed) of the storage device 120. In this case, the host device may monitor whether system performance has fallen below a given threshold. However, the monitoring carried out at S310 of FIG. 8A is not limited to these examples.

In the case where the monitoring of S310 determines that issuance of an invalidation command Inv_CMD is warranted (Yes at S320), the host device 110 issues an invalidation inquiry to the storage device 120 (S330). If no request for an invalidation command Inv_CMD is received from the storage device 120 (No at S340), the process ends (as shown) or returns to S310 to monitor whether issuance of another invalidation command Inv_CMD is warranted. In particular, the host device 110 does not issue the invalidation command Inv_CMD. Although not shown in the FIG. 8A, the host device 110 may log invalidation data (e.g., address data) associated with non-issued invalidation command(s) Inv_CMD in a data table or the like for later issuance. In this manner, the data associated with non-issued invalidation command(s) Inv_CMD is accumulated for later issuance.

On the other hand, in the case where a request for an invalidation command Inv_CMD is received from the storage device 120 (Yes at S350), the host device 110 issues the invalidation command Inv_CMD to the storage device 120 in order to increase the number of free blocks of the storage device 120. The issued invalidation command Inv_CMD may also include logged invalidation data relating to previously non-issued invalidation commands Inv_CMD. At this time, the host device 120 process ends (as shown) or returns to S310 to monitor whether issuance of another invalidation command Inv_CMD is warranted.

Referring now to FIG. 8B, the storage device 120 receives an invalidation inquiry from the host device 110 (S410).

The storage device 120 is responsive the invalidation inquiry to determine whether to transmit a request of an invalidation command Inv_CMD to the host device 110. In particular, the storage device 120 determines the number of free memory blocks or the number of non-free memory blocks among the memory blocks thereof in response to the FBS request from the host device 110. Alternatively, for example, the storage device 120 calculates a ratio of the free blocks to total memory blocks, and transmits the same to the host device 110. In the example of the present embodiment, in the case where the free block status (FBS) is less than the reference value (No at S420), the storage device 120 does not transmit the request for an invalidation command Inv_CMD, and instead returns to the beginning of the process to monitor whether issuance of another invalidation inquiry has been received from the host device 110 (S410).

After transmitting the free block status to the host device 110, the storage device 120 determines if an invalidation command Inv_CMD has been received from the host device 110 in return (S230). If not an invalidation command Inv_CMD is received (No at S230), the process is terminated.

On the other hand, according to the example of the present embodiment, in the case where the free block status (FBS) is equal to or more than the reference value (Yes at S420), the storage device 120 transmits the request for an invalidation command Inv_CMD to the host device 110 (S430). The invalidation command Inv_CMD is then received (S440), and the storage device 120 is responsive thereto to invalidate data or a data region that is designated by the invalidation command Inv_CMD (S450). The invalidation command Inv_CMD from the host device 110 may designate one or multiple files. In the case where multiple files are designated, or a plurality of invalidation commands Inv_CMDs are received, the storage device 120 may at one time invalidate data or a data region corresponding to the multiple files. As noted previously, data that has been invalidated by the storage device 120 may be excluded from merge/garbage collection of the storage device 120.

Those skilled in the art will appreciate that various modifications to the afore-described embodiments can be made without departing from the spirit and scope of the inventive concepts. For example, in a normal case, the storage device 120 is “passive” in the communication with the host device 110 is predicated upon first receiving a command or similar from the host device 110. However, the embodiments can be modified such a non-passive storage device 120 transmits the free block status (FBS) and/or request for invalidation command Inv_CMD without first being prompted by the host device 110. For example, the storage device 120 can be configured to periodically transmit the free block status (FBS) and/or request for invalidation command Inv_CMD, and/or to transmit the free block status (FBS) and/or request for invalidation command Inv_CMD when certain operating conditions are detected in the storage device 120.

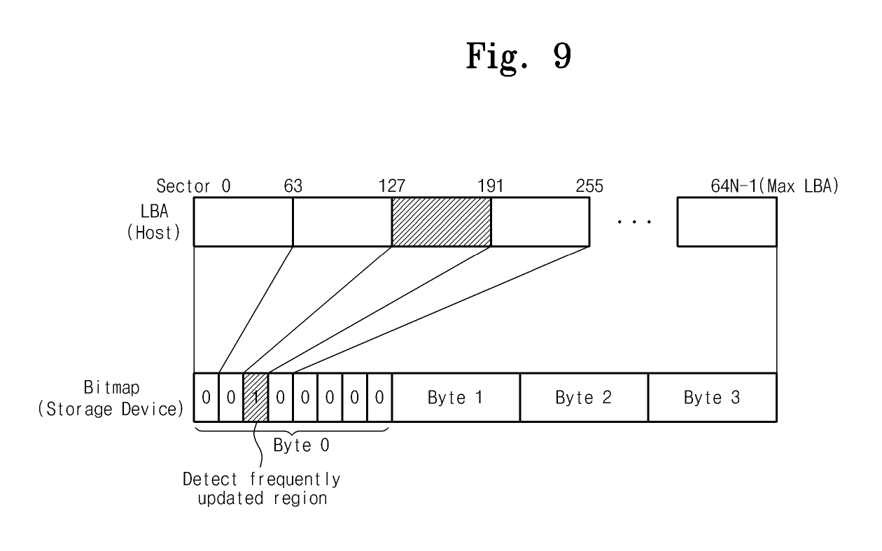

FIG. 9 is a diagram illustrating a feature utilized in a storage device 120 of FIG. 2 according to another embodiment of the inventive concepts.

The storage device 120 of this embodiment includes a bitmap for to allow for monitoring of the access frequency of data regions based on invalidation commands Inv_CMDs from a host device 110. As explained below, by monitoring the bitmap, the storage device 120 selectively logs or executes incoming invalidation commands Inv_CMDs from the host device 110.

Referring to FIG. 9, the bits of the bitmap may be configured in correspondence with designated logical address (LBA) regions of the host device 110. When a specific file is deleted from the host device 110, an invalidation command Inv_CMD corresponding to a deleted file is generated. The invalidation command Inv_CMD includes logical address (LBA) information corresponding to the deleted file or a data region to be invalidated. In the example of this embodiment, the storage device 120 sets the bit value of the bitmap corresponding to a logical address designated by the invalidation command Inv_CMD to logic ‘1’. When execution of the invalidation command Inv_CMD is complete, the storage device 120 resets the same bit value to logic ‘0’.

As a more detailed example, assume that the host device 110 has issued an invalidation command Inv_CMD for invalidating a data region corresponding to a sector 130 to the storage device 120. In the example of FIG. 9, sector 130 is contained in the data region corresponding to the third bit of Byte 0 of the bitmap of the storage device 120. Thus, upon receiving the invalidation command Inv_CMD, the storage device 120 sets the third bit of Byte 0 to logic ‘1’ in the bitmap. When the invalidation operation is completed with respect to the invalidated data of sector 130, the storage device 120 resets the third bit of Byte 0 of the bitmap to logic ‘0’.

The storage device 120 monitors the frequency with which each bit of the bitmap is set to logic ‘1’, and based on this monitoring, determines whether a data region corresponding to each bit of the bitmap is a “frequently updated” data region. For example, the storage device 120 may count the number of times each bit of the bitmap is set to logic ‘1’ within a given time period, and if the count number exceeds a given threshold for a given bit, the data region associated with that bit is deemed to be a frequently accessed data region. In the example of the present embodiment, the storage device 120 logs an invalidation command Inv_CMD which designates a frequently accessed data region, and the logged invalidation command Inv_CMD is executed at a later time. For example, logged invalidation command Inv_CMD may be executed during an idle time an idle time and/or when an invalidation command Inv_CMD for the data region has not been received for a given period of time (e.g., when the data region is no longer deemed frequently accessed).

Examples are presented below for further understanding of this embodiment of the inventive concepts.

As a first example, management of a log file in the file system of the host device 110 will be explained. In the file system, a logical address (LBA) region having an allocated log file may be frequently updated. In the log file, history or recovery information for the creation and erasure of a file by the file system is frequently updated. The log file, created in the working memory of the host device 110, is updated to the nonvolatile memory 123 periodically or when otherwise deemed necessary. When the creation request of a file is emitted, the file system configures a log file before a file creation operation is executed and first records history or recovery information. When the creation of a file is completed, the recorded log file is deleted.

Herein, the log file is allocated to a specific logical address section (for example, sector ‘0’ to sector ‘63’). Accordingly, a data region of the storage device 120, which is mapped to a logical address section to which the log file is allocated, is frequently updated. Therefore, an invalidation command Inv_CMD for a data region of the storage device 120 that stores the log file may be frequently generated. As a result, a specific bit of a bitmap corresponding to a logical address that pertains to the log file is frequently set.

As a second example, a case where the same file is frequently updated to a file having a different size will be described. When a relative large-size file is updated to a file having a smaller size, an invalidation command Inv_CMD for invalidating a data region equal to a size difference is generated. As a result, when a specific file is frequently updated to a file having a different size, an invalidation command Inv_CMD may also be generated frequently. This will be reflected by the corresponding bit of the bitmap.

As a third example, although not the same file, when the creation and deletion of a file are frequently performed, the probability increases that the frequency of generation of an invalidation command Inv_CMD for a specific logical address will increase. Such an example may be intuitively derived.

The above-described examples and the generation of frequent invalidation commands Inv_CMDs exerts a load on the host device 110 and the storage device 120. By logging for later execution an invalidation command Inv_CMD which designates a frequently accessed data region, the load on the storage device 120 can be reduced.

The embodiment described above conveniently utilizes a bitmap structure to monitor execution of invalidation commands Inv_CMDs for respective data regions. However, the inventive concepts are not limited to use of a bitmap, and other monitoring mechanism may be adopted

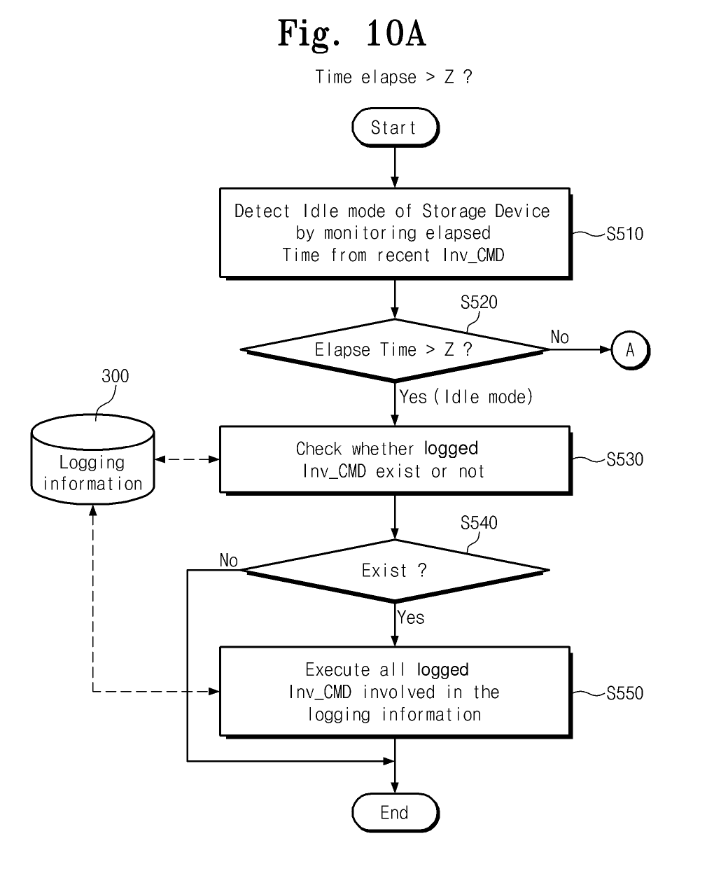

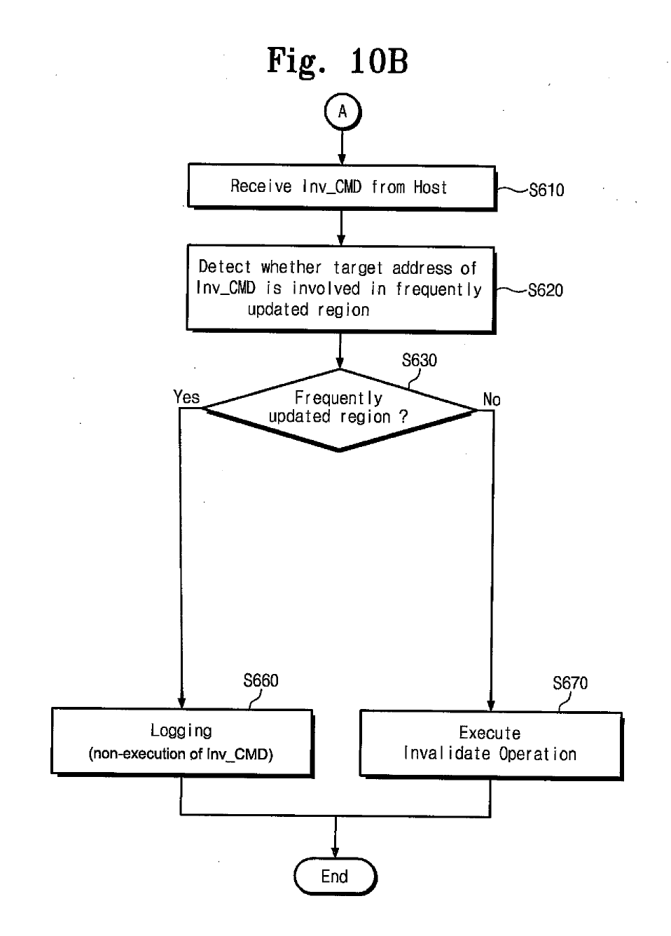

FIGS. 10A and 10B depict a flowchart for use in describing execution of a invalidation command Inv_CMD logging scheme in a storage device 120 such as that shown in FIG. 2, according to another embodiment of the inventive concepts.

Referring to FIG. 10A, in the example of this embodiment, the storage device 120 determines whether a drive mode of the storage device 120 is an idle mode or a normal mode (S510). For example, the storage device 120 may determine an elapsed time from the most recently input a command (CMD) from the host device 110. The most recently input command (CMD) may be an invalidation command Inv_CMD, a read command, a write command, and so forth.

In the example of this embodiment, when the elapsed time from the most recent command is more than a reference time ‘Z’ (Yes at S520), the storage device is deemed to be in an idle mode and the operation proceeds to S530. In this case, the storage device 120 scans logging information 300 to determine whether non-executed invalidation command(s) Inv_CMD have been previously logged (the logging process is described later in connection with FIG. 10B).

When non-executed invalidation command(s) Inv_CMD have not been logged (No at S540), the operation ends and/or returns to S510 detect any change in the drive mode of the storage device 120.

On the other hand, when one or more non-executed invalidation commands Inv_CMDs have been logged (Yes at S540), the storage device 120 executes the logged invalidation commands Inv_CMDs (S550). Here, the storage device 120 retrieves, for example, the logged addresses associated with the non-executed invalidation commands Inv_CMD, and executes the invalidation with respect to the retrieved addresses. The logging information 300 is then initialized after the logged invalidation commands Inv_CMDs are executed.

In the example of this embodiment, when the elapsed time from the most recent command is less than a reference time ‘Z’ (No at S520), the storage device is deemed to be in normal mode and the operation proceeds to S610 of FIG. 10B. The process of FIG. 10B is directed to the case where the storage device 120 receives an invalidation command Inv_CMD during a normal operational mode.

Referring to FIG. 10B, the storage device 120 receives an invalidation command Inv_CMD that has been issued by the host device 110 (S610). The storage device 120 decodes the invalidation command Inv_CMD and detects whether an address included in the decoded invalidation command Inv_CMD designates a data region that is frequently updated. Herein, the storage device 120 may perform this detection operation by monitoring a bitmap such as that described above in connection with reference to FIG. 9. However, this embodiment is not limited to the specific techniques discussed above in connection with FIG. 9. As one alternative, for example, the storage device 120 may monitor a time interval between received invalidation commands Inv_CMDs with respect to each data region, and designate a data region as frequently accessed when the time interval is less than a given threshold. Further, the bitmap and logging information 300 may be combined, and/or data indicative of frequently accessed memory regions may be contained in the logging information 300.

When the input invalidation command Inv_CMD does not designate a frequently updated region (No at S630), an operation proceeds to as to execute the input invalidation command Inv_CMD (S670). The operation process is then ended, and/or the process returns to S510 of FIG. 10A to assess the operating mode of the storage device 120.

When the input invalidation command Inv_CMD designated a frequently updated region (Yes at S630), the input invalidation command is not executed, and instead the input invalidation command Inv_CMD is logged in the logging information 300 (S660). The logging information 300 may, for example, be configured as a table in a working memory such as the buffer memory 122 shown in FIG. 2. Although the inventive concepts include logging the invalidation command Inv_CMD itself for later execution, the present embodiment includes logging of information associated with (decoded from) the invalidation command Inv_CMD that is necessary for later execution of the command. For example, address information associated with the invalidation command Inv_CMD may be logged.

At this time operation process is ended, and/or the process returns to S510 of FIG. 10A to assess the operating mode of the storage device 120.

By logging received invalidation commands Inv_CMDs designating frequently accessed data regions for later execution during an idle mode, the embodiment of FIGS. 10A and 10B may be effective to reduce an operational load on the storage device 120 during a normal operational mode.

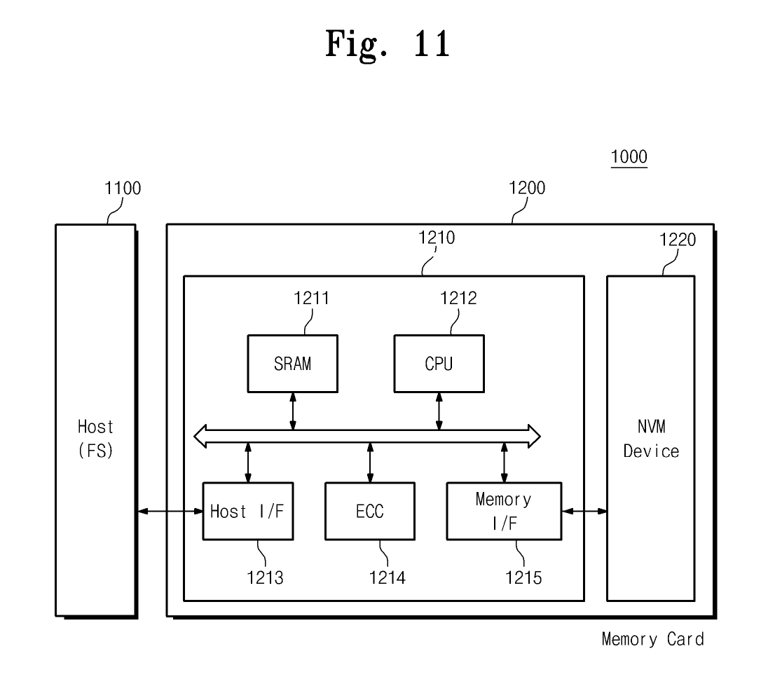

FIG. 11 is a block diagram schematically illustrating a user device which efficiently executes an invalidation command according to another embodiment of the inventive concepts.

Referring to FIG. 11, a user device 1000 according to another embodiment of the inventive concepts includes a host device 1100 and a memory card 1200.

The host device 1100 generates an invalidation command Inv_CMD according to any one or more of the above-described embodiments.

The memory card 1200 includes a nonvolatile memory device 1220 (NVM) and a memory controller 1210. The memory controller 1210 is configured to control the nonvolatile memory device 1220 in the same manner as the memory controller 120 of any one or more of the above-described embodiments. The memory controller 1210 communicates with an external device (for example, the host device 1100) through any one of various interface protocols such as a Universal Serial Bus (USB) protocol, a Multimedia Card (MMC) protocol, a Peripheral Component Interconnection (PCI) protocol, a PIC-Express (PCI-E) protocol, an Advanced Technology Attachment (ATA) protocol, a Serial-ATA protocol, a Parallel-ATA protocol, a Small Component Small Interface (SCSI) protocol, an Enhanced Small Disk Interface (ESDI) protocol, a Integrated Drive Electronics (IDE) protocol, an E-IDE protocol, and an eMMC protocol.

An SRAM 1211 is utilized as a working memory of the processing unit 1212. The host interface 1213 includes a data exchange protocol of the host device 1100 that is connected to the memory card 1200. An Error Correction Code (ECC) block 1214 detects and corrects data error that is read from the nonvolatile memory device 1220. The memory interface 1215 interfaces with the nonvolatile memory device 1220. The processing unit 1212 performs an overall control operation for the data exchange of the memory controller 1210.

Although not shown, it will be apparent to those skilled in the art that the memory card 1200 may be further provided with other components, such as a ROM (not shown) which stores code data for interfacing with the host device. Further, the nonvolatile memory device 1220 may be provided as a multi-chip package that is configured with a plurality of flash memory chips.

By adopting one or more embodiments of the inventive concepts, the user device 1000 may be operative to decrease the number of times an invalidation command Inv_CMD for a deleted file or a frequently-updated file is generated. Alternatively, the user device 1000 may be operative to log the invalidation command Inv_CMD for the deleted file or the frequently-updated file, substantially reducing the number of times an invalidation operation is performed.

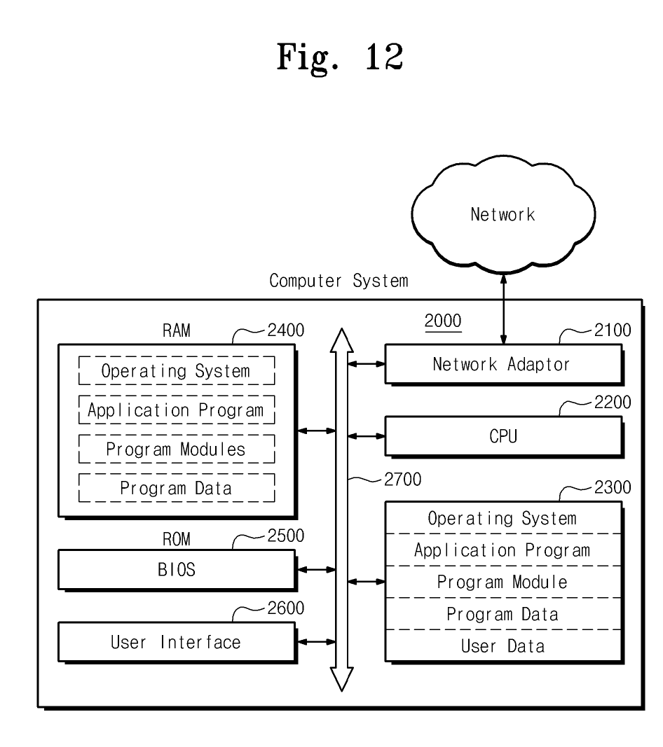

FIG. 12 exemplarily illustrates a computing system including a mass storage device according to an embodiment of the inventive concepts.

Referring to FIG. 12, a computing system 2000 according to an embodiment of the inventive concepts includes a network adaptor 2100, a Central Processing Unit (CPU) 2200, a mess storage device 2300, a RAM 2400, a ROM 2500 and a user interface 2600 that are electrically connected to a system bus 2700.

The network adaptor 2100 provides interface between the computing system 2000 and external networks. The CPU 2200 performs an overall operation for driving an application program or an Operating System (OS) that is included in the RAM 2400. The mass storage device 2300 stores data necessary for the computing system 2000. For example, the mass storage device 2300 stores an OS, an application program, various program modules, program data and user data, for driving the computing system 2000.

The RAM 2400 may be used as a working memory of the computing system 2000. When booting, the OS, the application program, the various program modules and the program data (which is used in the driving of programs) that are read from the mass storage device 2300 are loaded to the RAM 2400. The ROM 2500 stores a Basic Input/Output System (BIOS) that is activated before the OS is driven when booting. Information exchange between the computing system 2000 and a user is performed through the user interface 2600. In addition, the computing system 2000 may further include a battery and/or a modem. Moreover, although not shown, it will be apparent to those skilled in the art that the computing system 2000 may further include other components, such as an application chipset, a Camera Image Processor (CIS) and a mobile DRAM.

As described above, the mass storage device 2300 may include an SSD, an MMC card, a Secure Digital (SD) card, a micro SD card, a memory stick, an ID card, a PCMCIA card, a chip card, a USB card, a smart card, and a Compact Flash (CF) card.

The memory device and/or the storage controller according to embodiments of the inventive concepts may be mounted in various types of packages. For example, the memory device and/or the SSD controller according to embodiments of the inventive concepts may be mounted in packages such as Package on Package (PoP), Ball Grid Arrays (BGAs), Chip Scale Packages (CSPs), Plastic Leaded Chip Carrier (PLCC), Plastic Dual In-Line Package (PDIP), Die In Waffle Pack (DIWP), Die In Wafer Form (DIWF), Chip On Board (COB), Ceramic Dual In-Line Package (CERDIP), Plastic Metric Quad Flat Pack (MQFP), Thin Quad Flat Pack (TQFP), Small Outline Package (SOP), Shrink Small Outline Package (SSOP), Thin Small Outline Package (TSOP), Thin Quad Flat Pack (TQFP), System In Package (SIP), Multi Chip Package (MCP), Wafer Level Stack Package (WLSP), Die In Wafer Form (DIWF), Die On Waffle Package (DOWP), Wafer-level Fabricated Package (WFP) and Wafer-Level Processed Stack Package (WSP).

According to embodiments of the inventive concept, by decreasing or controlling the number of times the invalidation command is provided from the host and/or executed by the storage device, the operational performance of the user device can be enhance.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A storage device, comprising:
a data storage medium including a plurality of memory blocks; and
a storage controller which outputs a free memory block signal to a host device, and which is responsive to an externally received invalidation command from the host device to selectively invalidate data stored in the memory blocks of the storage medium,
wherein the free memory block signal is in accordance with a free memory block status of the data storage medium.

2. The storage device of claim 1, wherein the free memory block signal is indicative of a number of free memory blocks or a ratio of free memory blocks to total blocks.

3. The storage device of claim 2, wherein the storage controller is responsive to a request received from the host device to output the free memory block signal.

4. The storage device of claim 2, wherein the storage controller periodically outputs the free memory block signal.

5. The storage device of claim 1, wherein the free memory block signal denotes a request to receive the invalidation command from the host device.

6. The storage device of claim 5, wherein the free memory block signal is output when a number of free memory blocks or a ratio of free memory blocks to total blocks is less than a reference value.

7. The storage device of claim 6, further comprising a register for storing the reference value.

8. The storage device of claim 7, wherein reference value is user variable.

9. The storage device of claim 5, wherein the storage controller is responsive to an externally received request to transmit the free memory block status to an external device.

10. The storage device of claim 1, wherein the data storage medium includes a nonvolatile memory device, and the storage device is a Solid State Drive (SSD).

11. The storage device of claim 10, further comprising a memory buffer, and wherein the controller comprises:
a data bus;
a central processing unit operatively coupled to the data bus;
a host interface operative coupled to the data bus;
a nonvolatile memory interface operatively coupled to the data bus and the nonvolatile memory device; and
a buffer memory management unit operatively coupled to the data bus and the memory buffer.

12. A storage device, comprising:
a data storage medium including a plurality of memory blocks; and
a storage controller which receives an invalidation command from a host device, which logs the invalidation command when a target address of the invalidation command denotes a frequently updated region of the data storage medium, and which executes the invalidation command when the target address of the invalidation command does not denote a frequently updated region of the data storage medium.

13. The storage device of claim 12, wherein storage controller executes the logged invalidation command during an idle time of the storage device.

14. The storage device of claim 12, further comprising a bitmap storing data indicative of logical regions of the data storage medium designated by received invalidation commands.

15. The storage device of claim 14, wherein the storage controller monitors the bitmap to determine whether the designated address of the invalidation command denotes a frequently updated region of the data storage medium.

16. A computer system comprising:
a host device which generates an invalidation command; and
a storage device which includes data storage medium including a plurality of memory blocks, and a storage controller which executes the invalidation command generated by the host device to selectively invalidate data stored in the memory blocks of the storage medium,
wherein at least one of the generation of the invalidation command by the host device and the execution of the invalidation command by the storage controller is in accordance with a free memory block status of the data storage medium.

17. The computer device of claim 16, wherein the host device selectively generates the invalidation command by comparing the free memory block status of the data storage medium with a reference value.

18. The computer device of claim 17, wherein the storage device transmits the free memory block status to the host device.

19. The computer device of claim 16, wherein the storage device transmits a request for the invalidation command to the host device by comparing the free memory block status of the data storage medium with a reference value.

20. The computer device of claim 19, wherein the storage device further comprises a register for storing the reference value.

21. A computer system comprising:
a host device which generates an invalidation command; and
a data storage device which includes a storage controller and a data storage medium including a plurality of memory blocks;
wherein the storage controller receives the invalidation command from the host device, logs the invalidation command when a designated address of the invalidation command denotes a frequently updated region of the data storage medium, and executes the invalidation command when the designated address of the invalidation command does not denote a frequently updated region of the data storage medium.

22. The computer system of claim 21, wherein storage controller executes the logged invalidation command during an idle time of the storage device.

23. The computer system of claim 21, further comprising a bitmap storing data indicative of logical regions of the data storage medium designated by invalidation commands issued by the host device.

24. The computer system of claim 23, wherein the storage controller monitors the bitmap to determine whether the designated address of the invalidation command denotes a frequently updated region of the data storage medium.

25. A method of operating a storage device, the storage device including a data storage medium including a plurality of memory blocks, said method comprising:
outputting a free memory block signal to a host device, wherein the free memory block signal is in accordance with a free memory block status of the data storage medium; and
selectively invalidating data stored in the memory blocks of the storage medium in response to an invalidation command received from the host device.

26. The method of claim 25, wherein the free memory block signal is indicative of a number of free memory blocks or a ratio of free memory blocks to total blocks.

27. The method of claim 25, wherein the free memory block signal is output in response to a request received from the host device.

28. The method of claim 25, wherein the free memory block signal is output periodically.

29. The method of claim 25, wherein the free memory block signal denotes a request to receive the invalidation command from the host device.

30. The method of claim 25, wherein the free memory block signal is output when a number of free memory blocks or a ratio of free memory blocks to total blocks is less than a reference value.

31. The method of claim 1, wherein the data storage medium includes a nonvolatile memory device, and the storage device is a Solid State Drive (SSD).

32. A method of operating a storage device, the storage device including a data storage medium including a plurality of memory blocks, said method comprising:
receiving an invalidation command from a host device;
logging the invalidation command when a target address of the invalidation command denotes a frequently updated region of the data storage medium; and
executing the invalidation command when the target address of the invalidation command does not denote a frequently updated region of the data storage medium.

33. The method of claim 32, further comprising executing the logged invalidation command during an idle time of the storage device.

34. The method of claim 32, further comprising storing data in a bitmap indicative of logical regions of the data storage medium designated by received invalidation commands.

35. The method of claim 34, further comprising monitoring the bitmap to determine whether the designated address of the invalidation command denotes a frequently updated region of the data storage medium.

36. A method of operating a computer system, the computer system including a host device and a storage device which includes data storage medium including a plurality of memory blocks, said method comprising:
generating, by the host device, an invalidation command; and
executing, by the storage device, the invalidation command generated by the host device to selectively invalidate data stored in the memory blocks of the storage medium,
wherein at least one of the generation of the invalidation command by the host device and the execution of the invalidation command by the storage device is in accordance with a free memory block status of the data storage medium.

37. The method of claim 36, wherein the host device selectively generates the invalidation command by comparing the free memory block status of the data storage medium with a reference value.

38. The method of claim 36, wherein the storage device transmits the free memory block status to the host device.

39. The method of claim 36, further comprising, by the storage device, transmitting a request for the invalidation command to the host device based on a comparing the free memory block status of the data storage medium with a reference value.

40. A method of operating a computer system, the computer system including a host device and a storage device which includes data storage medium including a plurality of memory blocks, said method comprising:
transmitting, by the host device, an invalidation command to the storage device;
logging, by the storage device, the invalidation command when a designated address of the invalidation command denotes a frequently updated region of the data storage medium; and
executing, by the storage device, the invalidation command when the designated address of the invalidation command does not denote a frequently updated region of the data storage medium.

41. The method of claim 40, further comprising executing, by the storage device, the logged invalidation command during an idle time of the storage device.

42. The method of claim 40, further comprising storing, by the storage device, data in a bitmap indicative of logical regions of the data storage medium designated by invalidation commands issued by the host device.

43. The method of claim 42, further comprising monitoring, by the storage device, the bitmap to determine whether the designated address of the invalidation command denotes a frequently updated region of the data storage medium.
